(19) United States
(12) Patent Application Publication
(10) Pub. No.: US 2012/0298104 A1
(43) Pub. Date: Nov. 29, 2012

(54) RESPIRATOR DEVICE

(75) Inventors: Rüdiger MÜLLER, Stockelsdorf (DE); Joachim SCHLOBOHM, Bad Oldesloe (DE)

(73) Assignee: DRAGER SAFETY AG & CO. KGAA, Lubeck (DE)

(21) Appl. No.: 13/474,278

(22) Filed: May 17, 2012

(30) Foreign Application Priority Data
May 26, 2011 (DE) 10 2011 102 511.5

(51) Int. Cl. A62B 18/02; A62B 17/04

(52) U.S. Cl. 128/201.23; 128/207.11

(57) ABSTRACT

A device for respiration with a half mask (4) and with a strap (6) for pressing the half mask (4) onto the face of a mask user (7). Wearing comfort is facilitated by providing the strap (6) of a one-piece cut made of an elastic material and having at least one four-point connection with straps (9, 10) to the half mask (4).

### CROSS REFERENCE TO RELATED APPLICATIONS

This application claims the benefit of priority under 35 U.S.C. §119 of German Patent Application DE 10 2011 102 511.5 filed May 26, 2011, the entire contents of which are incorporated herein by reference.

### FIELD OF THE INVENTION

The present invention pertains to a device for respiration, which comprises a mask.

### BACKGROUND OF THE INVENTION

A device of this type has become known from DE 43 04 891 C2. A half mask, which is pressed against the mouth and nose by means of a strap extending at the back of the head, is located within a protective hood, which consists of a supple material. A breathing filter, via which the user of the hood is supplied with breathing air, is located at the half mask. The strap comprises individual, elastic straps, which are sewn together and are connected in a punctiform manner to the inside of the hood. The hood is dimensioned such that it accurately fits the heads of persons of different ages and has a window, which consists of a heat-resistant and chemical-resistant material. In case of danger, for example, in a fire, the hood must be pulled over the user's head and the half mask must now be sealingly in contact with the mask user's face. The drawback of the prior-art device is that by fastening the half mask at two opposite points, pressure points may develop on the mask user's face and when the hood is pulled over, the half mask will not be sealingly in contact with the mask user's face.

### SUMMARY OF THE INVENTION

A basic object of the present invention is to improve a device of the type described above in terms of wearing comfort.

According to the invention, a device is provided for respiration. The device comprises a mask and a strap for pressing the mask onto the face of a mask user. The strap is formed of a one-piece cut made of an elastic material and having at least one four-point strap to mask connection.

The four-point strap to mask connection may comprise two upper straps and two lower straps. The strap may comprise a middle part and outwardly extending straps defining sets of U-shaped straps extending from the middle part to the at least one four-point strap to mask connection.

The device may advantageously also comprise a hood covering the strap. The hood may include a fastening point fastening the strap on an inside of the hood. A spacer may also be present between the hood and the strap at the fastening point. The spacer may comprise an extension of a connection point of hood material of the hood.

Provisions are made according to the present invention for the strap to consist of a one-piece cut made of an elastic material and at least one four-point connection with the mask, preferably with a half mask. It is especially advantageous here to design the strap such that the straps extending to the half mask are guided both above and under the mask user's ears and tilting motions of the half mask in relation to the mask user's face are avoided as a result. The strap specified according to the present invention is not limited to half masks, but it also covers tools, full masks with hoods, full masks without hoods as well as mouthpieces, which are carried by the mask user.

The strap consists of an elastic textile as a flat object produced with the use of yarns consisting of fibrous materials, for example, natural fibers, or synthetic fibers. For example, knitted fabrics made of inelastic fibers are manufactured for preparation, or a fabric that consists of a mixture of elastic and inelastic fibers, or one that works with an elastic coating of a basic material. Such materials have an elongation of at least 300% in a preferential direction and at least 120% in other directions.

The textile cut is separated from the elastic textile web, for example, by punching. The further functional requirements imposed on the textile cut are determined by the one-piece cut. Good fixation of a respirator product is achieved without adjusting the straps at the mask user's head.

The advantages of this invention are, on the one hand, the easy and comfortable putting on of the respirator product, and, on the other hand, it is achieved hereby that the respirator product will be ready for use in a short time at the user of the device. It is especially advantageous for the user of the device that no adjustments of the strap are needed to achieve secure fit of the respirator product. No disturbing pressure points will develop on the device user's head or face due to the formation of a large-area holding point on the head. Sufficient holding and sealing function is achieved by means of the strap for all head sizes. Thus, it is also possible to use one textile cut for all head sizes. The one-part textile cut can also be used for optimal multiple connection to respirator products, for example, four-point connection to the mask body. The advantage of a four-point connection becomes manifest especially due to the specific distribution of the necessary holding forces of the breathing connection. The flat design is especially suitable for use under helmets for the device user. Disturbing pressure points on the head are avoided here as well. On the whole, this invention contributes to a high level of wearing comfort.

The elastic textile cut is advantageously inserted into a hood body such that a defined distance can be set by a spacer in the hood from the surface of the device user's head. Thermal effects from the outside can be markedly reduced hereby for the user of the device because an insulating layer of air is formed due to the spacer.

Exemplary embodiments of device according to the present invention are shown in the drawings and will be explained in more detail below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a schematic view showing a device for respiration with a hood;

FIG. 2 is a top view showing the cut for a strap without neck closure;

FIG. 3 is a top view showing the cut according to FIG. 2 with neck closure;

FIG. 4 is a partial sectional view showing a first embodiment with a spacer; and

FIG. 5 is a partial sectional view showing a second embodiment with a spacer.

### DESCRIPTION OF THE PREFERRED EMBODIMENTS

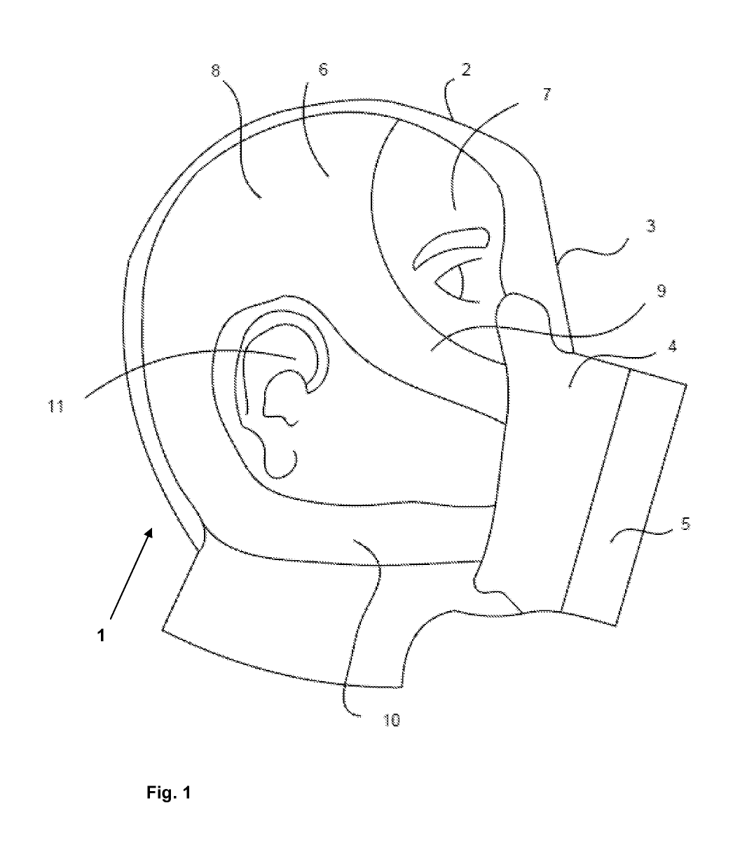

Referring to the drawings in particular, FIG. 1 schematically illustrates a respirator product 1, which comprises a hood 2 with an eye-protecting lens 3, with a half mask 4 arranged within the hood 2, with a filter 5 attached to the half mask 4, and with an elastic strap 6, which extends over the back of the head of the hood user 7, is connected to the half mask 4 and presses same onto the face of the hood user 7. Strap 6 is made in one piece from an elastic material and has a middle part 8 with two upper straps 9 and with two lower straps 10, which extend each in a U-shaped pattern on both sides of the hood user's 7 ears 11 and are connected at the free ends to the half mask 4. Only the right-hand half of the hood user's 7 head is shown in FIG. 1 for the sake of greater clarity.

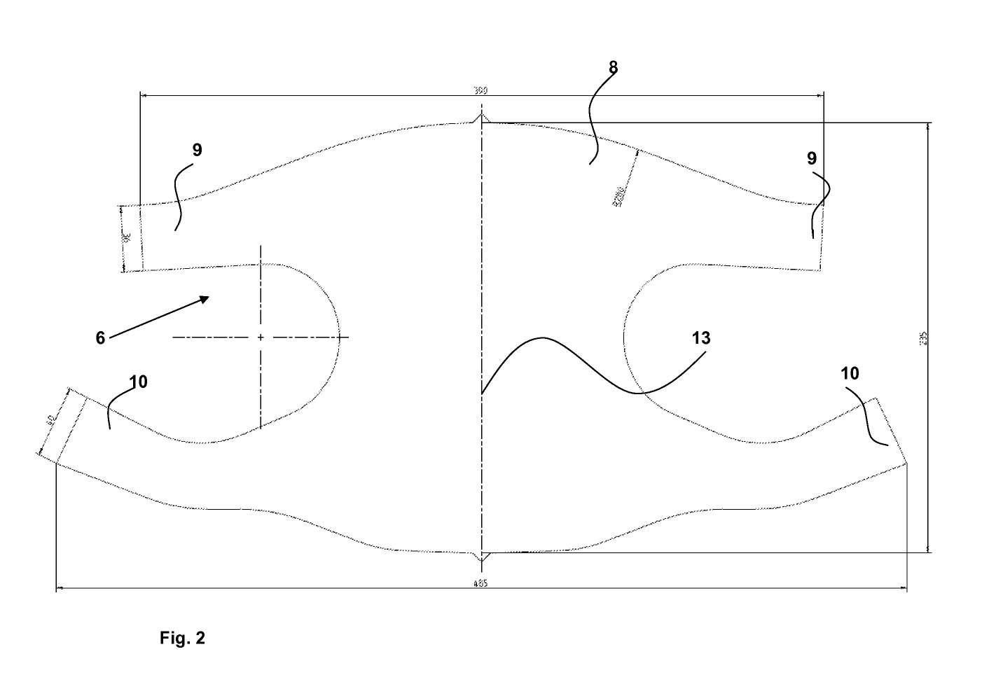

FIG. 2 shows the cut of strap 6. Identical components are designated by the same reference numbers as in FIG. 1. Due to the one-piece design of strap 6, the latter can be prepared in an especially simple manner by punching out a textile web or a knitted tube, as a knitted fabric. Strap 6 is made symmetrical with the center line 13.

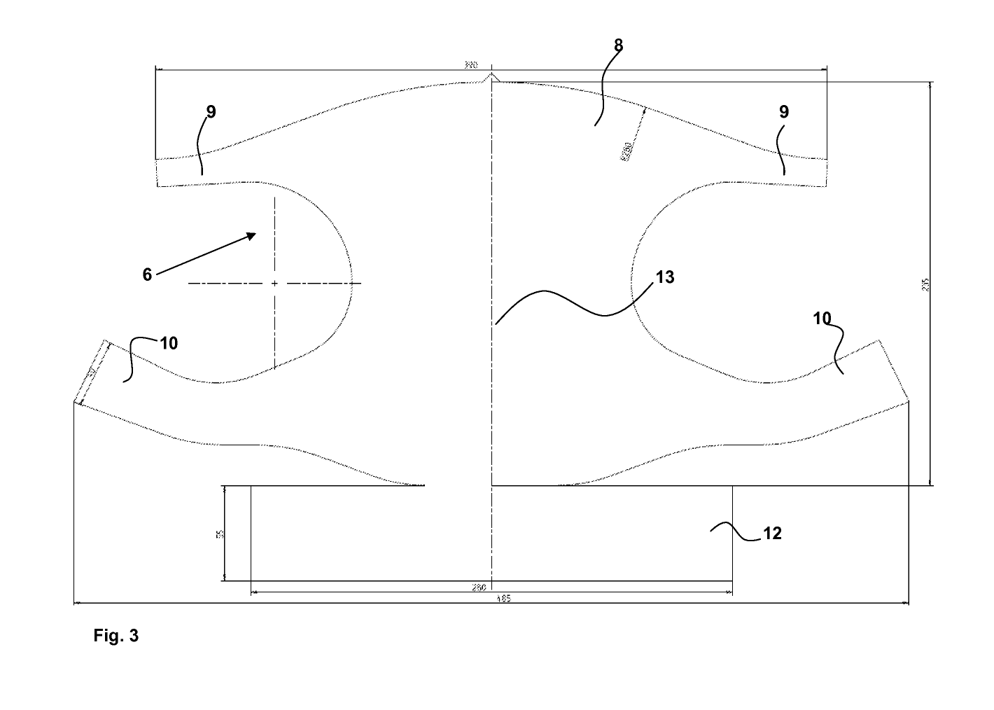

Strap 6 according to FIG. 3 is distinguished by the embodiment corresponding to FIG. 2 by an additional neck closure 12. The cut has a width, measured along center line 13, of about 240 mm±20 mm and a length, measured between the free ends of the upper straps 9, of about 390 mm. The width of the upper straps 9 and lower straps 10 equals about 40 mm. With these basic dimensions, strap 6 can be adapted especially well to heads of different shapes and sizes.

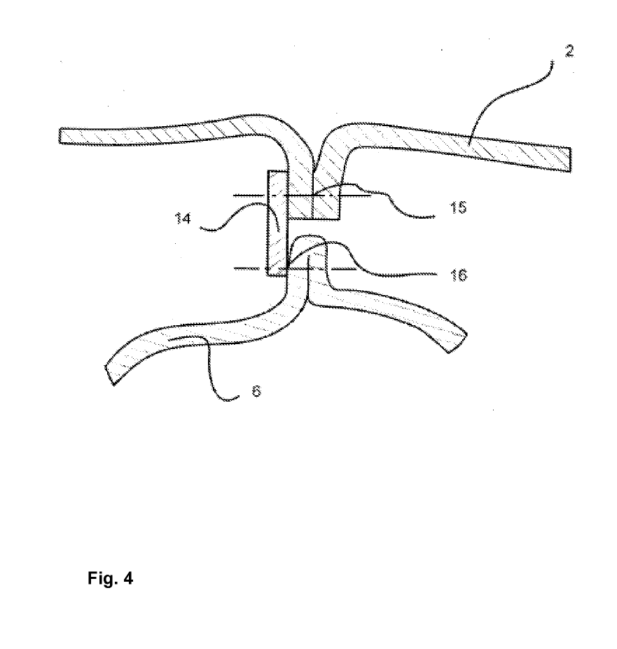

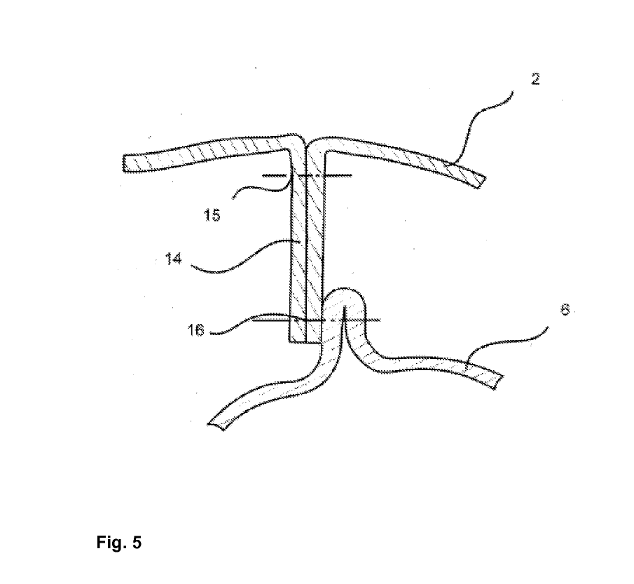

FIG. 4 shows an embodiment with a spacer 14 between a first fastening point 15 on the hood 2 and a second fastening point 16 on the strap 6. The second fastening point 16 is preferably located in the area of center line 13 of strap 6, and the strap 6 is folded over here and connected as a fold to form the second fastening point 16. The strap can be sewn together, welded together or bonded in the area of the fold. The first fastening point 15 is preferably a connection point or seam point in the area of the hood material. Instead of a separate spacer, the seam of the hood material is designed as an extension of the first fastening point 15 as a spacer 14 in an alternative embodiment according to FIG. 5. Both the first fastening point 15 and the second fastening point 16 are located here in the area of the hood material.

While specific embodiments of the invention have been shown and described in detail to illustrate the application of the principles of the invention, it will be understood that the invention may be embodied otherwise without departing from such principles.

### APPENDIX

### List of Reference Numbers

1 Respirator product
2 Hood
3 Eye-protecting lens
4 Half mask
5 Filter
6 Strap
7 Hood user
8 Middle part
9 Upper straps
10 Lower straps
11 Ears
12 Neck closure
13 Center line
14 Spacer
15 First fastening point, connection point
16 Second fastening point

What is claimed is:

1. A device for respiration, the device comprising:
a mask; and
a strap for pressing said mask onto the face of a mask user, said strap being formed of a one-piece cut made of an elastic material and having at least one four-point strap to mask connection.

2. A device in accordance with claim 1, wherein said four-point strap to mask connection comprises two upper straps and two lower straps.

3. A device in accordance with claim 1, wherein said strap comprises a middle part and outwardly extending straps defining sets of U-shaped straps extending from the middle part to said at least one four-point strap to mask connection.

4. A device in accordance with claim 1, further comprising:
a hood covering said strap, said hood being provided in such a way that said strap has at least one fastening point to said hood on an inside of said hood.

5. A device in accordance with claim 4, further comprising: a spacer present between said hood and said strap at said fastening point.

6. A device in accordance with claim 5, wherein said spacer comprises an extension of a connection point of hood material of said hood.

7. A device in accordance with claim 1, wherein said strap consists of an elastic textile material with an elongation of at least 120%.

8. A device in accordance with claim 1, wherein said mask is a half mask or a full mask.

9. A device for respiration, the device comprising:
a mask; and
a strap with a middle part for engaging a head of a wearer of the device and pressing said mask onto a face of the wearer via four strap portions extending from the middle part and terminating in a four-point strap to mask connection, said strap being formed of a single sheet of elastic material with said middle part and four strap portions cut from said single sheet of elastic material as a single piece integral part.

10. A device in accordance with claim 9, wherein said four strap portions comprise two upper straps and two lower straps.

11. A device in accordance with claim 9, wherein said strap portions extend outwardly from said middle part and define two sets of U-shaped straps extending from the middle part to said at least one four-point strap to mask connection.

12. A device in accordance with claim 9, further comprising:
a hood covering said strap, said hood including a strap fastening location on an inside of said hood, said strap being connected to said hood at said strap fastening location.

13. A device in accordance with claim 12, further comprising: a spacer present between said hood and said strap at said fastening location.

14. A device in accordance with claim 13, wherein said spacer comprises an extension of hood material of said hood.

15. A device in accordance with claim 9, wherein said strap consists of an elastic textile material with an elongation of at least 120%.

16. A device in accordance with claim 9, wherein said mask is a half mask.
